(19) United States
(12) Patent Application Publication
(10) Pub. No.: US 2004/0078331 A1
(43) Pub. Date: Apr. 22, 2004

(54) Payment system using electronic stamps

(76) Inventor: Adonis El Fakih, Nashua, NH (US)

Correspondence Address: Richard C. Litman, LITMAN LAW OFFICES, LTD., P.O. Box 15035, Arlington, VA, 22215, US

(21) Appl. No.: 10/683,297

(22) Filed: Oct. 14, 2003

Related U.S. Application Data
(60) Provisional application No. 60/419,269, filed on Oct. 17, 2002.

(51) Int. Cl. G06F 17/60

(52) U.S. Cl. 705/40; 705/39

(57) ABSTRACT

The payment system using electronic stamps is a system and method for making payments for goods and services, in an electronic commerce environment, using electronic stamps. The system uses electronic stamps in the form of an electronic carrier media, such as a JPEG image file, that contains embedded identification and payment information. The identification and payment information is embedded into the carrier media using a steganographic packing technique, along with other encryption. Accounting information is maintained by a payment service provider to associate a monetary value with the electronic stamp. When an electronic stamp is presented for payment, and successfully authenticated, funds allocated to the electronic stamp are reallocated to a merchant account maintained by the payment service provider. Funds are aggregated in the merchant account until a sufficient balance is reached, when the merchant is paid by electronic funds transfer, check, cash, or any suitable arrangement.

### CROSS-REFERENCE TO RELATED APPLICATION

This application claims the benefit of U.S. Provisional Patent Application Serial No. 60/419,269, filed Oct. 17, 2002.

### BACKGROUND OF THE INVENTION

1. Field of the Invention

The present invention relates to electronic payment of goods and services over the Internet. More specifically, the present invention is payment system using electronic stamps, comprising a system and method of creating, and a system and method of using, electronic stamps for payment of goods and services over the Internet. The electronic stamps are also useful for authentication of documents including identification cards and documents.

2. Description of the Related Art

Electronic commerce is exemplified by, but certainly not limited to, the sale of goods and services over the Internet. The Internet, connecting millions of users to a wide variety of information sources, news sources, merchants, financial trading services, and countless more services than can be listed, has revolutionized the way business is conducted.

Not only have World Wide Web (the Web) sites provided an alternative to traditional brick-and-mortar storefronts and mail-order, allowing shoppers to purchase goods from commercial Web sites, the Internet and the Web allow for the sale of goods and services in ways that were inconceivable, or impractical, before the Internet. Music, for example, can be purchased and downloaded electronically one song at a time for a fraction of the cost of an entire audio CD. Or, a song may be “purchased” for only a single play. Pictures, news clippings, and other individualized information products can be individually sold or even “sold” for a single viewing. Services and transactions can be performed, such as online banking transactions, investment services, e-mail services and more, each on an individualized basis and each for a small fee.

A significant obstacle to the sale on the Internet of many such individualized services and goods is the transaction cost associated with traditional payment methods, often a credit card. When a consumer wants to purchase a single song for a single play, perhaps for only a few cents, the transaction costs of making a payment might exceed a reasonable price for purchase itself. Additionally, the steps required for entering a credit card number and authenticating information for such small purchases may be discouraging.

Internet merchants have employed various payment systems to alleviate the transaction cost and inconvenience inherent to payment for small purchases, including subscription fees, prepay arrangements similar to a gift certificate or store credit, and other payment systems whereby a consumer can make a single, relatively large, payment for several subsequent and relatively small purchases. These systems, however, tend to restrict the customer to a single Internet merchant, lacking the ability to easily make numerous small purchases from numerous Internet merchants.

A system and method for making small payments, also known as “micropayments”, easily and flexibly in the Internet and Web environment is needed.

U.S. Patent Publication 2002/0111907, published on Aug. 15, 2002, discloses systems and methods for conducting electronic commerce transactions requiring micropayment. A micropayment service provider sells electronic tokens to Internet consumers. The tokens are used for purchases from electronic commerce vendors who accept the tokens for payment. However, the tokens are personally associated with a consumer and require a username and password to authorize payment. The consumer's credit card and other personal information are retained, and the card is charged as token payments are aggregated.

U.S. Patent Publication 2002/0007351, published on Jan. 17, 2002, discloses a system and method relating to digital tokens for use in electronic commerce. The tokens are particularly useful in a system and method to distribute licenses for copyrighted material separate from the copyrighted material itself.

U.S. Pat. No. 5,771,289, issued on Jun. 23, 1998 to A. Kuzma, discloses a method and apparatus for transmitting an electronic message wherein a payment is required for the transmission. Payment is made as messages are transmitted using previously obtained electronic stamps.

None of the above inventions and patents, taken either singly or in combination, is seen to describe the instant invention as claimed. Thus a payment system using electronic stamps solving the aforementioned problems is desired.

### SUMMARY OF THE INVENTION

The payment system using electronic stamps includes a system and method for making payments in electronic commerce using an electronically packed, electronic stamp media referred to herein as CENTIPIX. CENTIPIX is a trademark of the Centipaid Corporation of Nashua, N.H.

A CENTIPIX electronic stamp is a form of electronic currency for use in electronic commerce that is useful for micropayments, as well as for other electronic payments. The CENTIPIX is an electronic carrier media, such as a JPEG image file, that contains embedded identification and payment information. The CENTIPIX does not contain information that identifies an individual consumer, but contains information to uniquely identify itself. The CENTIPIX thus functions as a digital stored value card.

The CENTIPIX may also be used to convey credit card information to function as an online, digital credit card.

Additionally, because the CENTIPIX electronic stamp provides a secure and robust method of encoding and transferring identification information, the CENTIPIX may be employed to tag documents for authentication and identification.

CENTIPIX are created by an issuing agent, and sold to a CENTIPIX micropayment service provider (MSP). Consumers purchase CENTIPIX, either from the CENTIPIX MSP or from a reseller. When the consumer purchases the CENTIPIX, payment for the CENTIPIX is made to the MSP, and a CENTIPIX of a given face value is transferred to the consumer. Thus, the consumer takes possession of a CENTIPIX of a given initial value, and the funds represented by the CENTIPIX are stored electronically by the MSP. The CENTIPIX is stored in the consumer's computer, or on a data storage media such as a floppy diskette, smart card, magnetic swipe card, or other media from which the customer may use or transfer the CENTIPIX.

When the consumer makes a purchase, from an online merchant that accepts CENTIPIX, the consumer is directed to an MSP associated with the merchant and asked to present a valid CENTIPIX. The consumer then transmits a copy of a valid CENTIPIX to the MSP, and the CENTIPIX is authenticated for payment. Payment is deducted from the CENTIPIX balance and credited to the merchant. A receipt for the transaction is issued to the consumer, and the receipt is forwarded to the merchant to complete the requested purchase.

Accordingly, it is a principal object of the invention to provide a payment system using electronic stamps.

It is another object of the invention to provide a payment system using electronic stamps that comprise an electronic carrier media that contains embedded identification and payment information.

It is a further object of the invention to provide a payment system using electronic stamps for simplified payment in electronic commerce.

Still another object of the invention is to provide a payment system using electronic stamps for making micropayments in electronic commerce.

Yet another object of the invention is to provide a payment system using electronic stamps to convey credit card information to facilitate credit card transactions online.

A still further object of the invention is to provide a system and method of authenticating documents using electronic stamps.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1A is a system diagram showing a payment system using electronic stamps of the present invention.

FIG. 1B is a diagram showing an Internet implementation of a payment system using electronic stamps of the present invention.

FIG. 1C is a block diagram of a network appliance in a payment system using electronic stamps of the present invention.

FIG. 1D is a block diagram of a server computer in a payment system using electronic stamps of the present invention.

FIG. 1E is a block diagram showing distribution of software components in a payment system using electronic stamps of the present invention.

FIG. 2A is a flowchart describing a method of assembling electronic stamps according to the present invention.

FIG. 2B shows a blank image file used as an electronic carrier media for electronic stamps according to the present invention.

FIG. 2C shows the image of an assembled electronic stamp according to the present invention.

FIG. 2D illustrates a database and a database record for validation of an electronic stamp according to the present invention.

FIG. 3 is a flowchart describing a method of validating an electronic stamp according to the present invention.

FIG. 4 is a flowchart describing a method of purchasing electronic stamps according to the present invention.

FIG. 5A is a flowchart describing a TCP/IP payment client interface for communicating electronic stamp payment requests to a payment server.

FIG. 5B is a flowchart describing an interactive electronic stamp payment client employing the TCP/IP payment client described in FIG. 5A.

FIG. 5C is a flowchart describing an unattended electronic stamp payment client employing the TCP/IP payment client described in FIG. 5A.

FIG. 6A is a flowchart describing a TCP/IP payment server interface for receiving electronic stamp payment requests from a payment client.

FIG. 6B is a flowchart describing the validation, by the TCP/IP payment server described in FIG. 6A, of a “free pass” type of electronic stamp.

FIG. 6C is a flowchart describing the validation and payment, by the TCP/IP payment server described in FIG. 6A, of an electronic stamp.

FIG. 6D is a flowchart describing communication between a TCP/IP payment server and another TCP/IP payment server to resolve payment of an unknown electronic stamp.

FIG. 7 is a flowchart describing a receipt server according to the present invention.

FIG. 8A is a flowchart describing a typical e-commerce transaction employing a payment system using electronic stamps of the present invention.

FIGS. 8B is a screen shot illustrating a Web page having a paid link to purchase a product using an electronic stamp.

FIGS. 8C is a screen shot illustrating a Web page requesting that a customer upload an electronic stamp for payment of a product.

FIGS. 8D is a screen shot illustrating a Web page requesting that a customer upload an electronic stamp for payment of a product, along with a dialog box for selecting the electronic stamp.

FIGS. 8E is a screen shot illustrating a Web page confirming that an electronic stamp is accepted for payment of a product.

FIGS. 8F is a screen shot illustrating a Web page informing a customer that an electronic stamp was rejected for payment of a product.

FIG. 9A is a schematic diagram of an alternate embodiment of a payment system using electronic stamps wherein an electronic stamp is used as an electronic credit card.

FIG. 9B is a flow chart describing an Internet transaction using the payment system using electronic stamps depicted in FIG. 9A.

Similar reference characters denote corresponding features consistently throughout the attached drawings.

### DETAILED DESCRIPTION OF THE PREFERRED EMBODIMENTS

The present invention is a payment system using electronic stamps. The payment system using electronic stamps facilitates electronic commerce by providing “CENTIPIX” electronic stamps (CENTPIX), which can be freely used for payment in Internet transactions of any value, including micropayments. CENTIPIX is a trademark of the Centipaid Corporation of Nashua, N.H.

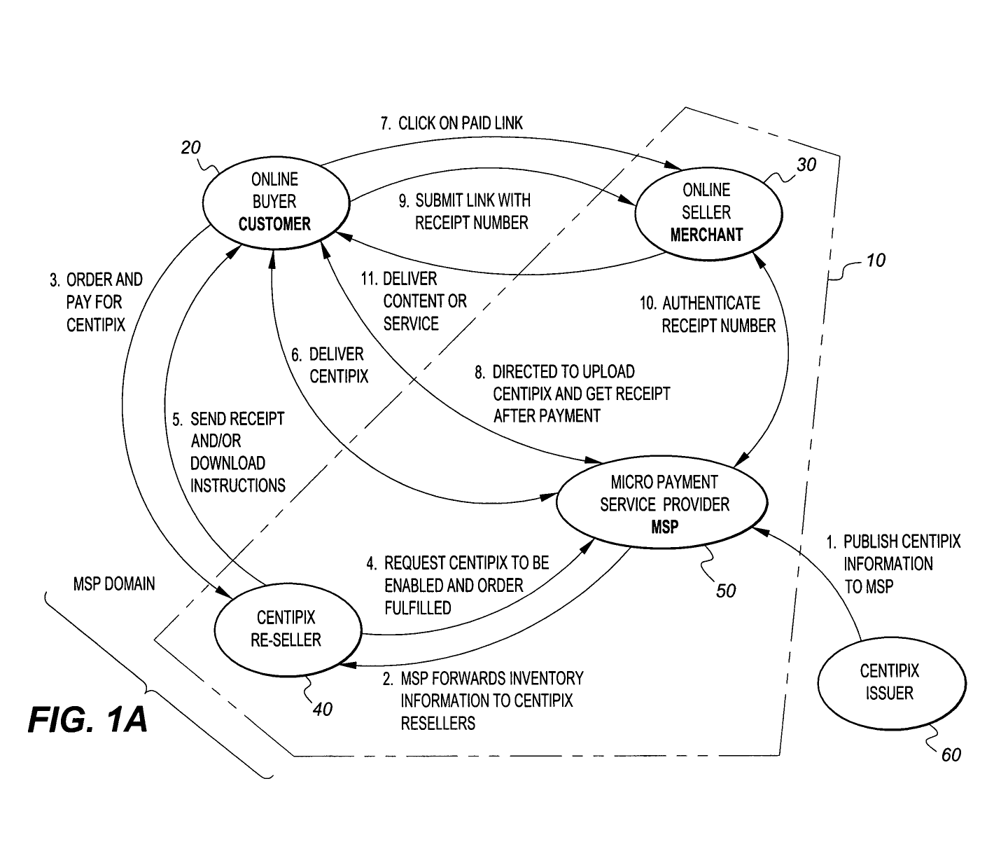

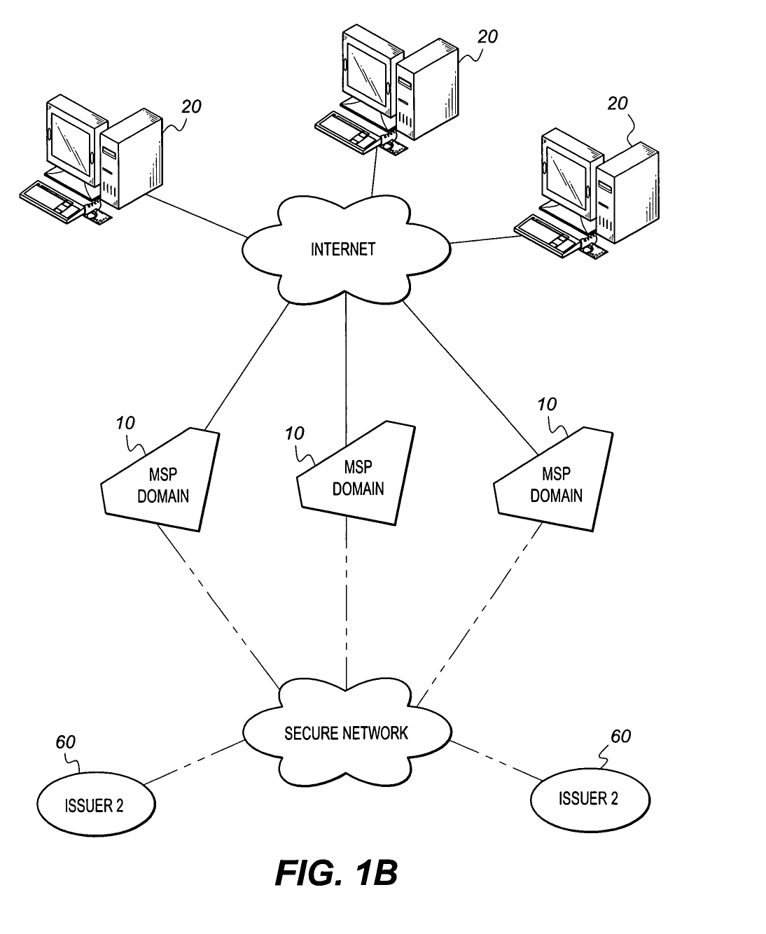

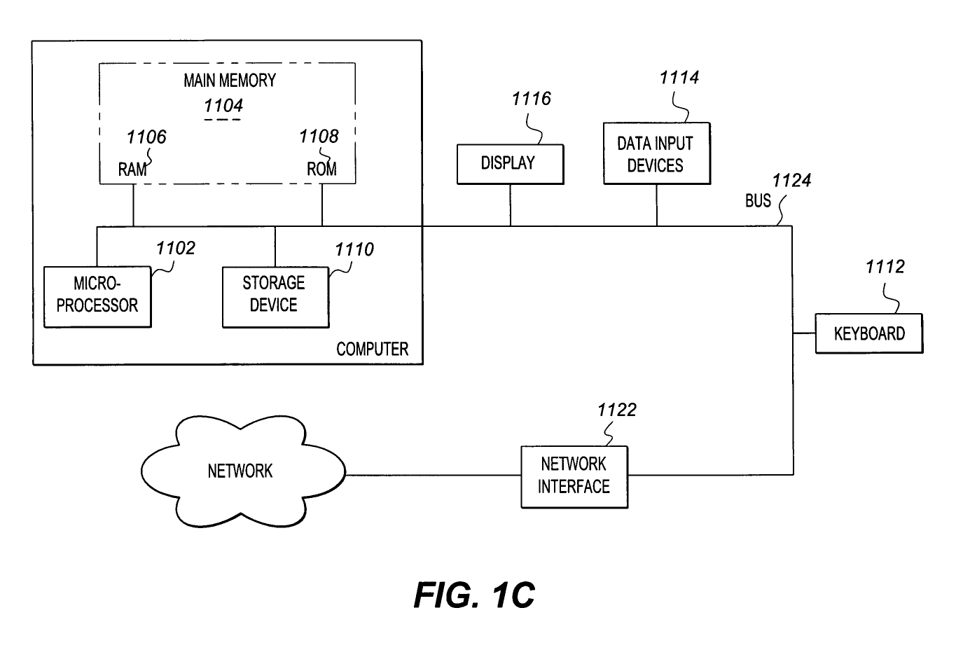

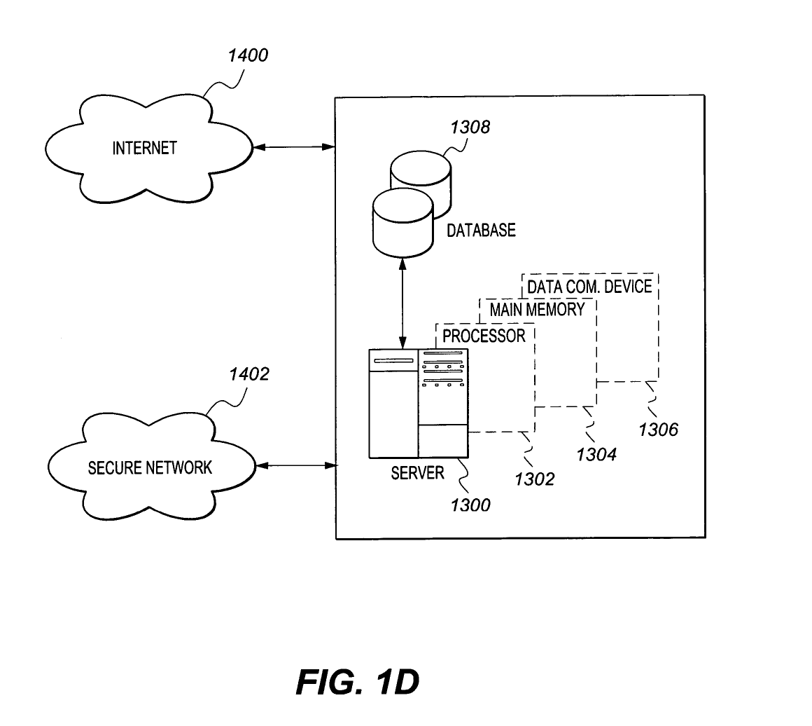

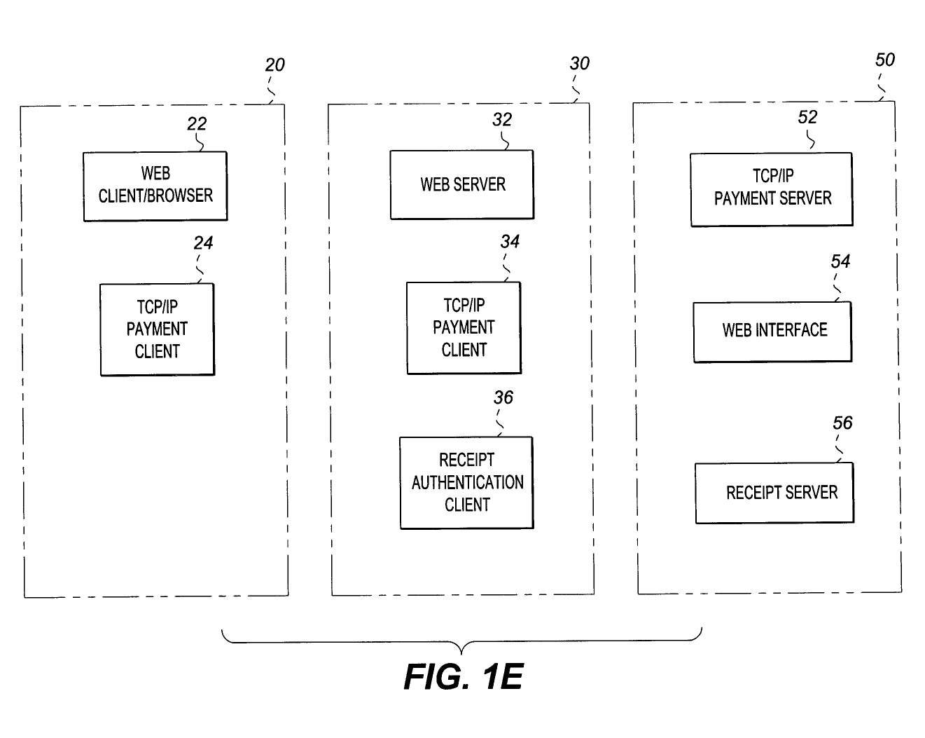

FIG. 1A illustrates a payment system using electronic stamps. The electronic stamps are created by an issuer 60, and distributed to a micropayment service provider (MSP) 50. The MSP stores an inventory of the electronic stamps. A customer 20 purchases electronic stamps, either directly from the MSP 50 or, as shown, from a reseller 40. The electronic stamps may be issued as prepaid cards of fixed value, such as $5.00, $10.00, $20.00, or as “refillable” cards of a value according to the customer's discretion. Typically, the customer 20 will buy the electronic stamps online, paying with a credit card. The MSP 50 maintains an accounting database for the funds associated with each electronic stamp. The electronic stamps are delivered to the customer 20 by e-mail, or by another electronic file transfer method such as File Transfer Protocol (FTP). The electronic stamps are stored by the customer 20 until needed for an online purchase.

When a customer 20 wants to purchase online content or services, or physical goods, from an online merchant 30, a paid link on the merchant 30 website will redirect the customer to an associated MSP 50, using a Uniform Resource Locator (URL) that describes the customer 20 and his purchase, and identifies the merchant 30. In response, the MSP 50 presents the customer 20 with a request to submit an electronic stamp for payment for the purchase.

The customer 20 transfers a copy of the electronic stamp to the MSP 50, where the electronic stamp is validated. If the electronic stamp is valid, the accounting record for the electronic stamp is accessed. If sufficient funds associated with the electronic stamp remain, the purchase amount is debited from the electronic stamp and credited to an accounting record that is maintained for the merchant 30, and a receipt is issued to the customer 20. The customer 20 submits the receipt to the merchant 30, who authenticates the receipt with the MSP 50. Once the receipt is authenticated, the merchant 30 delivers the product to the customer 20.

Generally, although not as a rule, a merchant 30 is associated with a single MSP 50, and the MSP 50 with a single reseller 40. An MSP domain 10 defines a grouping of merchant 30, reseller 40, and MSP 50. The MSP 50 that provides payment services for a merchant 30 maintains a merchant database. For each merchant 30 in the merchant database, a record includes identification and accounting information for the merchant 30.

Turning now to FIGS. 1B-1E, a customer 20 is represented in the Internet environment by a network appliance, such as a personal computer (PC), in communication over the Internet with numerous MSP domains 10, who in turn communicate among themselves and with issuers 60 on a secure network. Illustrated in FIG. 1C, a typical personal computer has a microprocessor 1102 connected by a bus 1124 to an area of main memory 1104, comprising both read only memory (ROM) 1108, and random access memory (RAM) 1106, and a storage device 1110 having means for reading a coded set of program instructions on a computer readable medium which may be loaded into RAM 1106 and executed by the microprocessor 1102. The personal computer has a keyboard 1112, and may include other input devices 1114 such as a mouse, joystick, etc. Additionally, the computer has a display 1116 for video display, and a network communication interface 1122 for serial communications on a network or other serial communications link. An Internet client program or Web browser 22, such as Microsoft Internet Explorer, running on the Internet appliance, gives the customer 20 access to the Internet and to the Web. In some arrangements, a payment client 24 will run on the Internet appliance, in communication with the Internet client program or Web browser 22. As an alternative to a personal computer, a customer 20 can use a notebook computer, personal digital assistant (PDA), a cellular telephone or other wireless device, or any other kind of Internet appliance.

The merchant 30, reseller 40, MSP 50, and issuer 60 are each represented in the Internet environment by a server computer configured to function in the Internet, e-commerce environment. FIG. 1D illustrates a typical server computer 1300. The server 1300 has a processor 1302 for processing instructions and an area of memory 1304 for executing program code under the direction of the processor 1302, and a data communication device 1306 for network communications. The network data communication device 1306 preferably provides both unrestricted access on the Internet 1400, and communication on a secure network 1402. A database 1308 may reside in an area of disk storage on the server 1300 and be connected to the server memory by a bus, or may reside on a remote database server accessible by the server 1300, as is known in the art.

The merchant 30 typically implements a Web server program 32 to provide a presence on the Web for interaction with customers 20. Additionally, the merchant 30 may, optionally, implement a payment client 34 to support electronic payment for goods, content, and services, using the CENTIPIX for payment. It is preferred, however, that payment client 24, running on the customer 20 Internet appliance be used, or that the payment client function be performed by the MSP 50.

The MSP 50 implements a payment server 52, and a receipt server 56 which allow parties involved in a CENTIPIX paid transaction to make payment, and then to verify the validity of a receipt confirming payment. Additionally, the MSP implements a Web interface 54 to facilitate CENTIPIX transactions on Internet Web sites. The Web interface 54 may additionally, in some arrangements, perform the function of the payment client.

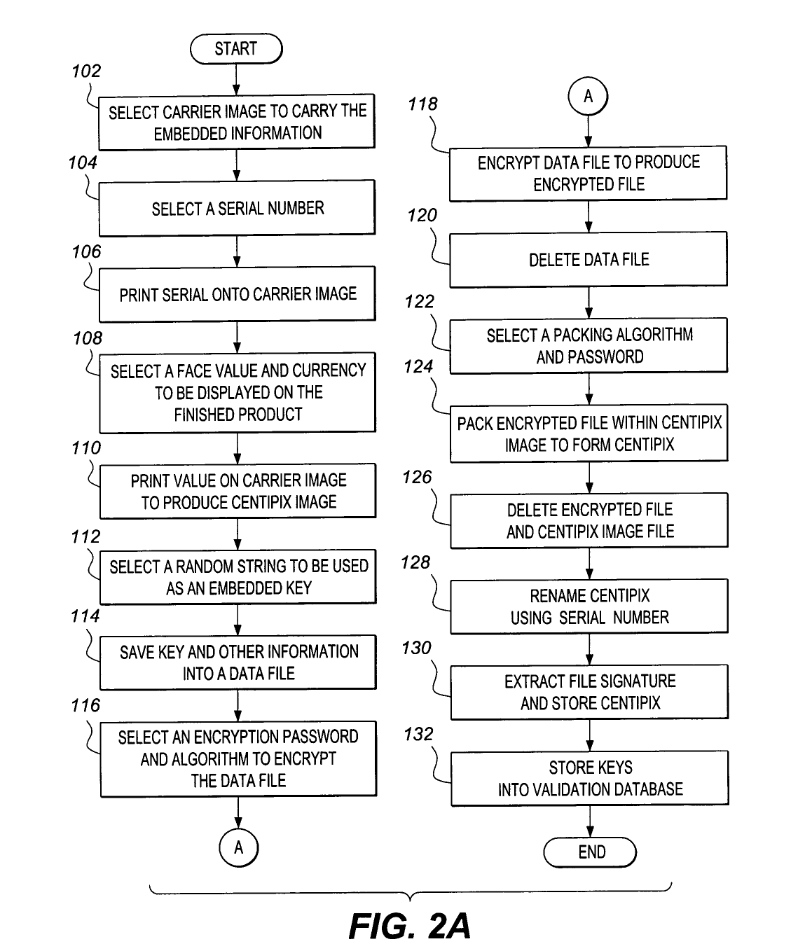

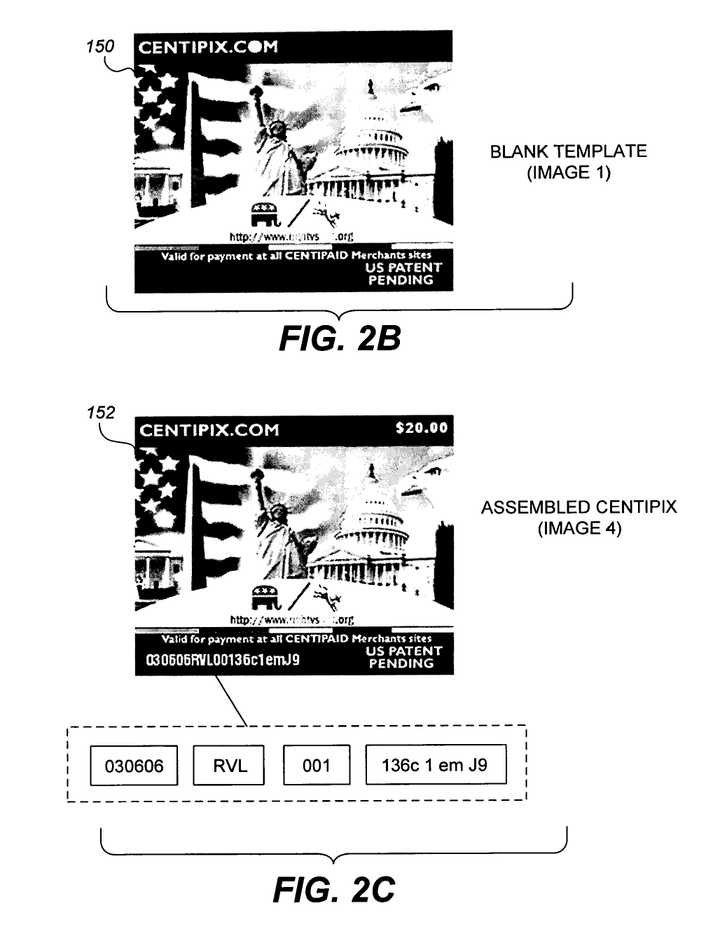

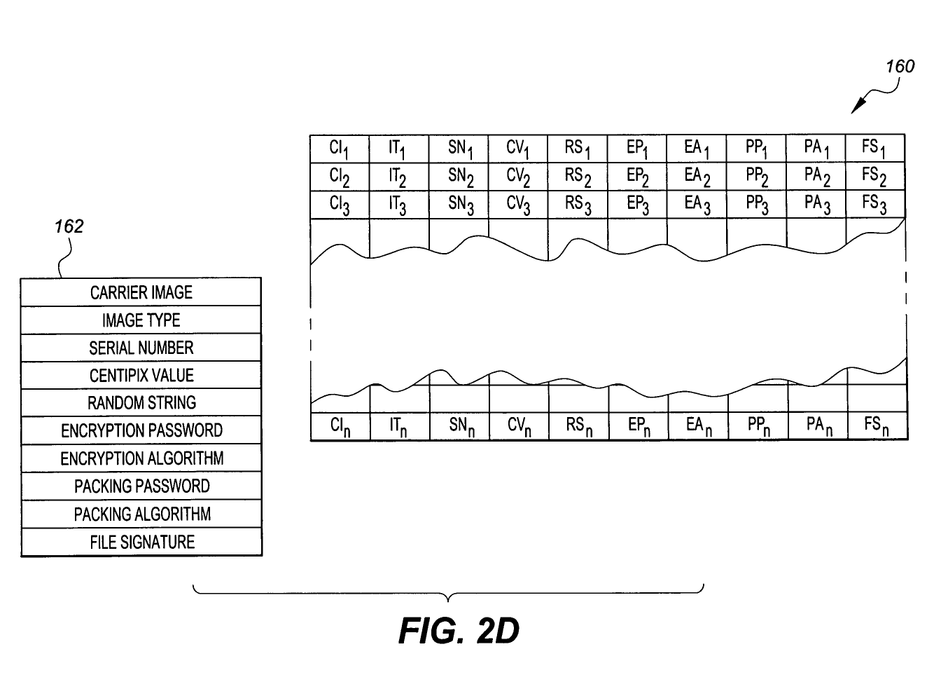

Turning now to FIGS. 2A-2D, a process for creating CENTIPIX electronic stamps is detailed. A CENTIPIX electronic stamp (“CENTIPIX”) comprises an electronic carrier media in which identification and payment information is embedded. The preferred embodiment uses an image file, such as a JPEG or GIF image, as the electronic carrier media. It can be readily appreciated, of course, that many other file formats are suitable. The process starts with the selection of a carrier image 150 file that will be used as the electronic carrier media (step 102). The image selection, as well as selection of a suitable file format for the image, is influenced by the technique that will be used to embed data within the image. In the present embodiment, data will be distributed throughout the image using a steganographic packing technique, producing an image that is readily viewable in any existing image viewer. Alternatively, data could be packed at the start or end of the image file, or packed within a specific graphic format, requiring a special viewer to view the CENTIPIX.

The carrier image 150 can be based on any basic image, allowing the CENTIPIX to be customized or personalized. The carrier image 150 is marked with standard visual indicia to enable users to visually distinguish the electronic stamp as a CENTIPIX. FIG. 2B shows an example of a CENTIPIX electronic stamp carrier image.

The next step in assembling a CENTIPIX is to create a serial number (step 104), and to “print” the serial number onto the carrier image 150 to that the serial number becomes a visible part of the carrier image 150 (step 106). The serial number is a unique identifier for the CENTIPIX. The format of the serial number is largely a matter of software design choice. In the present embodiment, the serial number is an alphanumeric string made up of several parts used to identify the issuer, a series, and dates of assembly. In a alternate embodiment, wherein the CENTPIX functions as an electronic credit card instead of a prepaid currency, a credit card number or a variation of a credit card number may be used as the serial number.

The next step is to select an initial value (face value) for the CENTIPIX, which may include a value and a currency (step 108), and to print the value and currency on the carrier image 150 to produce the CENTIPIX image 152 (step 110), seen in FIG. 2C. In alternate embodiments, wherein the CENTPIX functions as an electronic credit card instead of a prepaid currency or wherein the CENTIPIX is used as an electronic or digital identification card, these steps are not applicable.

At this point, the CENTIPIX image 152 is complete. The next several steps are directed to embedding identification and payment information within the CENTIPIX image 152.

A random string is generated (step 112) to be used as an embedded key for authenticating the CENTIPIX. The random string is a variable length string of random numbers. It is recommended that the random numbers are not related to any other elements of this process and, more importantly, they are not related to each other.

A first data file is created, and the random string is stored in the first data file along with the serial number generated in step 104 above (step 114). The random string and the serial number are sufficient to identify the CENTIPIX, however additional data may stored within the first file as a matter of design choice.

The first data file is then encrypted for increased security. An encryption password is selected (step 116), and the first data file is encrypted using the encryption password to produce an encrypted data file (step 118). The encryption is performed using any available encryption algorithm, such as AES, TwoFish, RSA, Blowfish, and others. The first data file can be deleted after creation of the encrypted data file (step 120).

The encrypted data file is then packed within the CENTIPIX image 152. A packing algorithm, and a packing password, are selected (step 112). in the present embodiment, the packing algorithm is a steganographic algorithm that packs the contents of the encrypted data file within the CENTIPIX image 152 by distributing the contents of the second data file throughout the CENTIPIX image 152. Numerous commercial, shareware, and freeware software packages for steganography are available supporting various algorithms for different image types.

Using the steganographic packing algorithm, the encrypted data file is merged, or packed, within the CENTIPIX image 152 (step 124) to form the CENTIPIX file. The encrypted data file and the CENTIPIX image file 152 are now deleted (step 126), and the CENTIPIX file is renamed, using the serial number selected in step 120 as the CENTIPIX file name (step 128).

A file signature is extracted from the CENTIPIX file, and the CENTIPIX file is stored in a known location (step 130). The file signature is a checksum such as a CHECKSUM32 value, or a digital signature such as an MD5 digital signature, that is used to verify data integrity of the CENTIPIX. An MD5 digital signature is preferred for providing a more robust digital signature.

With the CENTIPIX created, the various artifacts used for its creation are stored in a validation database record 162 within a validation database 160 (step 132). These include the carrier image and image type, the serial number, the CENTIPIX value, the random string, the encryption password and encryption algorithm, the packing password and the packing algorithm, the file signature, and the location of the CENTIPIX. The validation database record 162 for a CENTIPIX thus contains all information necessary to validate the CENTIPIX.

Returning to FIG. 1A, it can now be appreciated that when an issuer 60 transfers an inventory of CENTIPIX to an MSP 50, the validation database 160 is transferred as well so that the MSP 50 has, in addition to an inventory of CENTIPIX, all of the information necessary to validate the CENTIPIX. The MSP 50 retains the validation database 160, with no validating information distributed to a reseller 40, a merchant 30, or a customer 20.

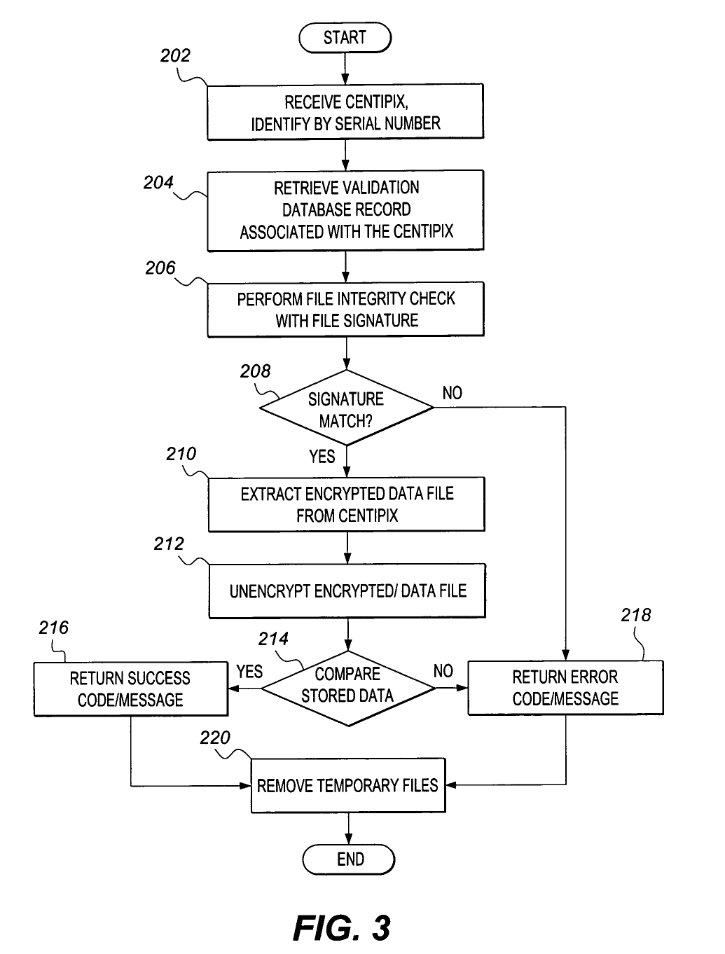

When a customer 20 presents a CENTIPIX to an MSP 50 for payment for a transaction, the CENTIPIX must be validated before funds can be transferred to the account of the merchant 30. Referring to FIG. 3, the process for validating a CENTIPIX is detailed.

Validation of a CENTIPIX begins when the MSP 50 receives the CENTIPIX from the customer. The MSP 50 identifies the serial number associated with the CENTIPIX, the serial number being contained within the CENTIPIX file name (step 202) as well as contained within the CENTIPIX itself. Using the serial number, the validation database record 162 associated with the CENTIPIX is retrieved from the validation database 160 (step 204). The file signature, found in the validation database record 162, is used to perform a file integrity check (step 206). If the file integrity is OK, the validation continues. Otherwise, an error message is generated (step 218), working files are deleted (step 220), and the validation process is terminated.

If the CENTIPIX passes the file integrity check, the validation process continues by extracting the encrypted data file from the CENTIPIX (step 210). The extraction is performed according to the packing algorithm, and using the packing password, specified in the validation database record 162. The encrypted data file is then unencrypted to produce the first data file (step 212). The decryption is performed according to the encryption algorithm, and using the encryption password, specified in the validation database record 162.

The contents of the first data file are then compared with data contained in the validation database record 162, to authenticate the CENTIPIX (step 214). If the data matches, the CENTIPIX is authenticated and a success code or message is generated (step 216). Otherwise, if the data does not match, the CENTIPIX is invalid, and an error code or message is generated (step 218). Working and temporary files are deleted (step 220), and the validation process is complete.

Returning again to FIG. 1A, it can now be appreciated that when a customer 20 presents a CENTIPIX to an MSP 50 to make a payment, the CENTIPIX is validated and accepted for payment solely based on the contents of the CENTIPIX and the validation database 160 maintained by the MSP 50. No additional information is required from the customer 20 to complete the transaction.

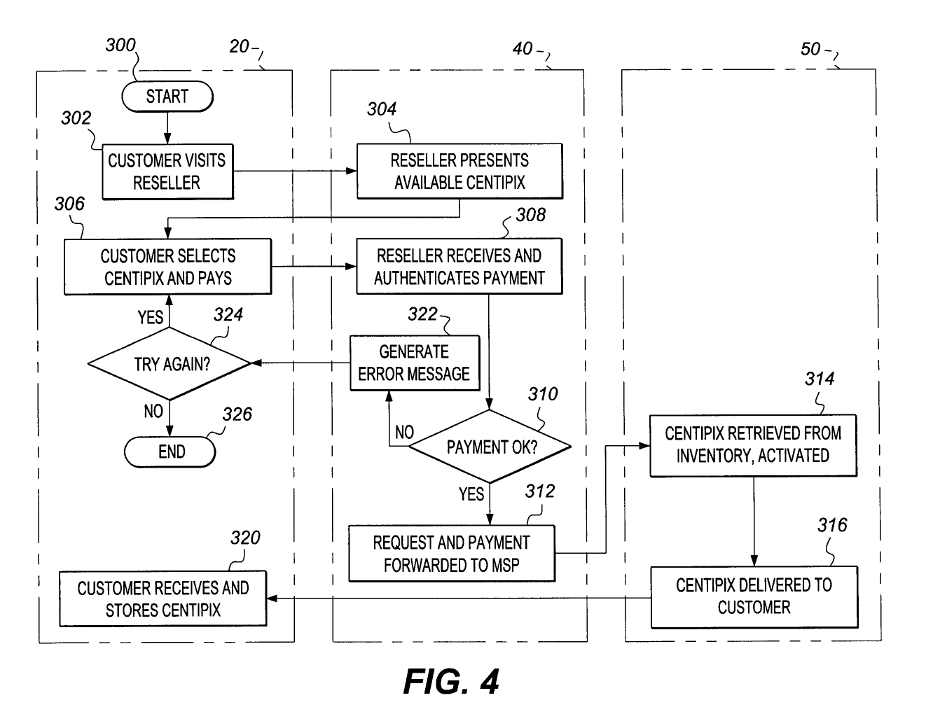

Turning now to FIG. 4, the purchase of CENTIPIX is detailed. Customers 20 may buy CENTIPIX from a variety of sources. Primarily, CENTIPIX will be purchased online. However, it is also possible for CENTIPIX to be sold in traditional retail stores and other environments where the customer 20 may purchase CENTIPIX in person, using cash, checks, or other forms of payment unsuitable for an online transaction.

Most typically, the customer 20 will purchase CENTIPIX from a reseller 40, visiting the reseller 40 in person or online (step 302). In some arrangements, the customer 20 may purchase CENTIPIX directly from an MSP 50, where the reseller 40 is bypassed completely or the MSP 50 fills the role of the reseller 40. The reseller 40 presents available CENTIPIX to the customer 20 for selection (step 304). CENTIPIX may be provided in various forms. For example, the CENTIPIX my be available as prepaid cards of fixed value, such as $5.00, $10.00, $20.00, or as “refillable” cards of a value according to the customer's discretion. CENTIPIX may be restricted to use only at specific e-commerce sites, within a restricted domain, or within a limited time frame. Additionally, CENTIPIX may bear diverse visual images to suit the personality and preference of various customers. The customer chooses a CENTIPIX from the available selections, and pays for the CENTIPIX (step 306).

In purchasing a CENTIPIX online, payment is made online with a credit card, e-check, or another means suited to the e-commerce environment. Payment may be made offline for an online purchase, for example by mailing a check or other payment to the reseller 40. Cash, checks, or other means may be used when a CENTIPIX is purchased in person. With a credit card payment online, the reseller receives and authenticates the credit card number supplied to approve payment (step 308). If the credit card is approved, the request and payment for the CENTIPIX are forwarded to the MSP to fulfill the request (step 312). The MSP 50 retrieves a CENTIPIX according to the customer's request, and activates the CENTIPIX by marking the validation database record for the CENTIPIX as active (step 314).

The activated CENTIPIX is delivered to the customer 20 (step 316). The CENTIPIX may be delivered to the customer 20 by email or by another Internet file transfer method. Alternatively, the CENTIPIX may be delivered to the customer 20 physically, on a data storage media such as a floppy diskette, smart card, magnetic swipe card, or other media from which the customer 20 may use the CENTIPIX or transfer the CENTIPIX to the customer's PC, or another PC or Internet appliance. The CENTIPIX may be used directly from the data storage media without being stored on a PC or Internet appliance. Additionally, numerous copies of the CENTIPIX can be made and each copy stored and used separately. Typically, the customer 20 will receive the CENTIPIX and store the CENTIPIX on the customer's PC (step 320).

If the credit card payment was declined, an error message is generated (step 322) and the customer 20 is given the option to try again, either reentering the credit card information correctly or entering a different card (step 324).

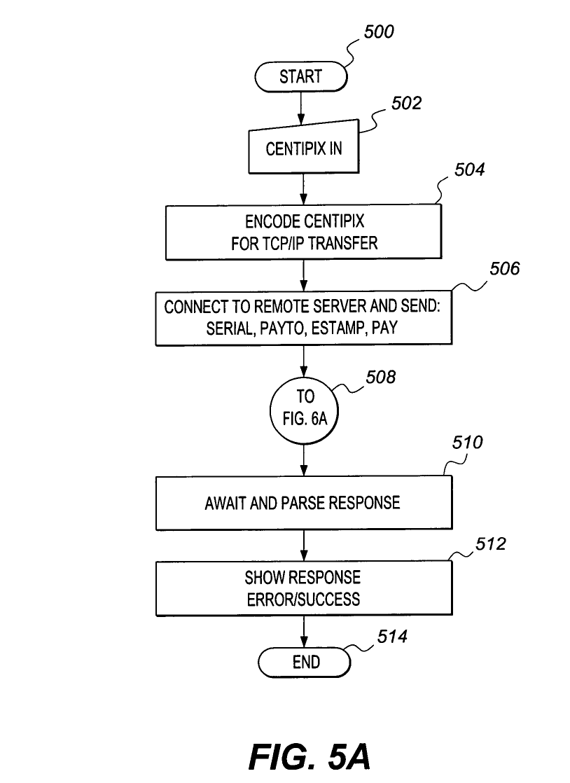

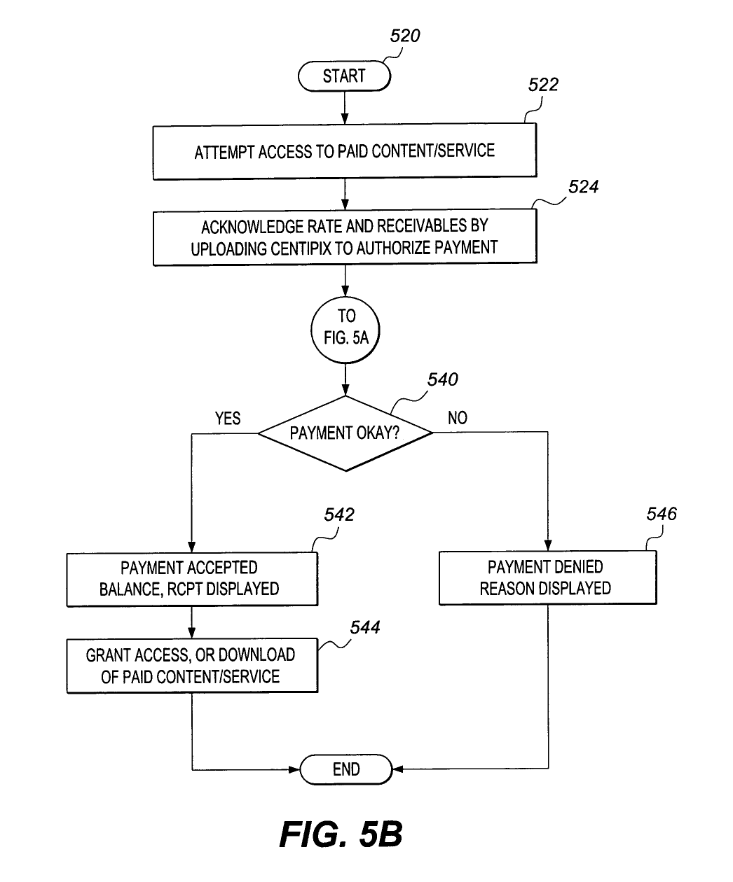

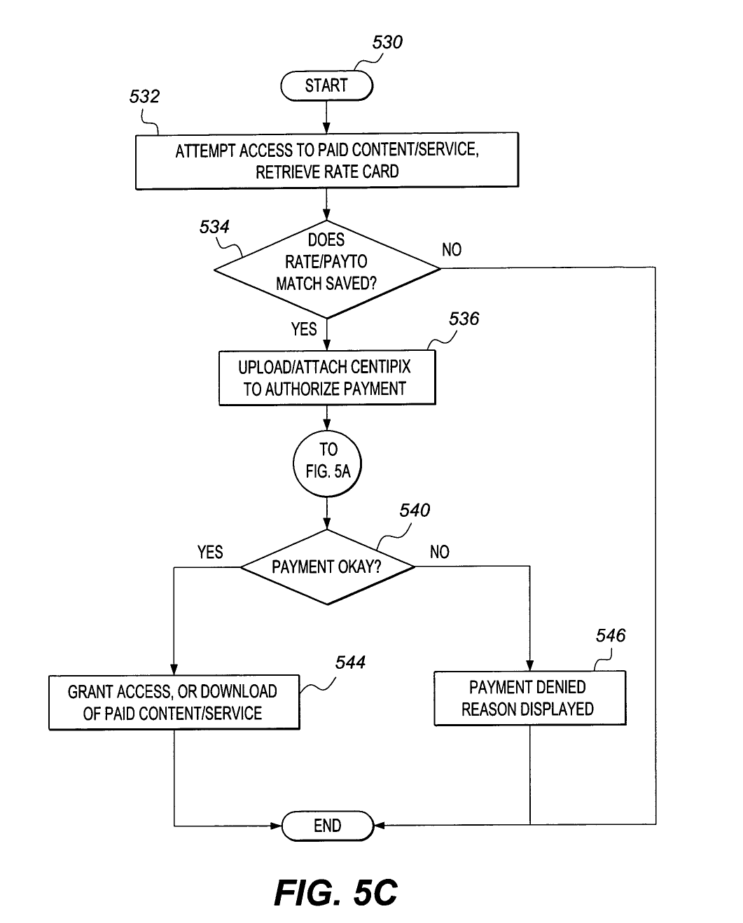

The MSP 50 includes a TCP/IP payment server 52, which is responsible for all CENTIPIX payments. A request to the payment server 52 to pay for a transaction using a CENTIPIX is made by a TCP/IP payment client 24, sending the CENTIPIX along with information about the transaction. Referring to FIG. 5A, the payment client 24 receives the CENTIPIX (step 502) along with additional information about the transaction, including the amount to pay and the payee. The CENTIPIX is formatted for TCP/IP transfer (step 504), a TCP/IP connection is established with the payment server 52, and a payment request is sent to the payment server 52 (step 506). An example of a TCP/IP request according to a simple API is:

SERIAL:<the centipix serial number>

PAYTO:<the merchant's identifier>

ESTAMP:<the centipix file>

PAY:<the amount to be paid>

QUIT

The payment client 24 waits for, and then receives and processes, a response from the payment server 52 (step 510). An example of a response from the payment server 52 is:

250 OK SERIAL:<the centipix serial number>

250 OK PAYTO:<the merchant's identifier>

250 OK ESTAMP ACCEPTED FOR VERIFICATION

250 OK AMOUNT:<amount paid>

The response is displayed, reflecting the success or error status of the transaction (step 512).

The payment client may be incorporated into an interactive client, such as a WEB interface, or into an unattended client such as a paid email service client. FIG. 5B illustrates the use of an interactive client, and FIG. 5C illustrates the use of an unattended client. The primary difference between the interactive client and the unattended client is that the interactive client prompts the customer 20 to select and upload a CENTIPIX for payment, while the unattended client automatically submits a CENTIPIX without requiring intervention of the customer 20. Both the interactive client and unattended client begin by attempting to access some paid content or service from an online merchant (steps 522, 532). Because the unattended client completes the transaction without customer intervention, the unattended client employs a “rate card”, or a table of various merchants and a spending limit for each merchant. Thus, if the unattended client encounters a price for a service that, according to the rate card, is excessive, the unattended client does not complete the transaction (step 534). The interactive client allows the customer to accept the payment amount, and select and upload a CENTIPIX for payment (step 524), while the unattended client automatically submits a CENTIPIX if the payment amount is within the rate card (step 536). The transaction is performed with the TCP/IP payment client 24 communicating with the TCP/IP payment server 52. Both the interactive client and the unattended client receive a response from the payment server, and determine if the payment transaction was successful (step 540). If the payment was unsuccessful, a message is displayed (step 546). If the payment was successful, the interactive client displays an indication of success including the remaining CENTIPIX balance and a receipt identifier (step 542). The unattended client omits this display, since the unattended client is intended to function without customer intervention. Both clients then grant access to, or download the paid content or service (step 544).

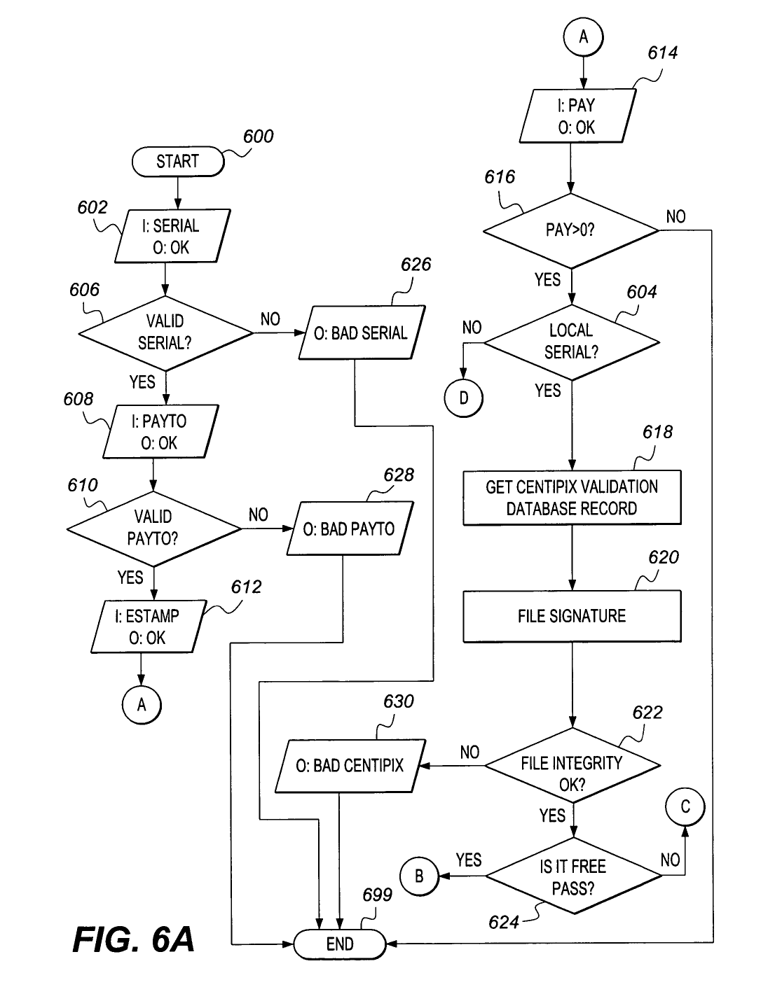

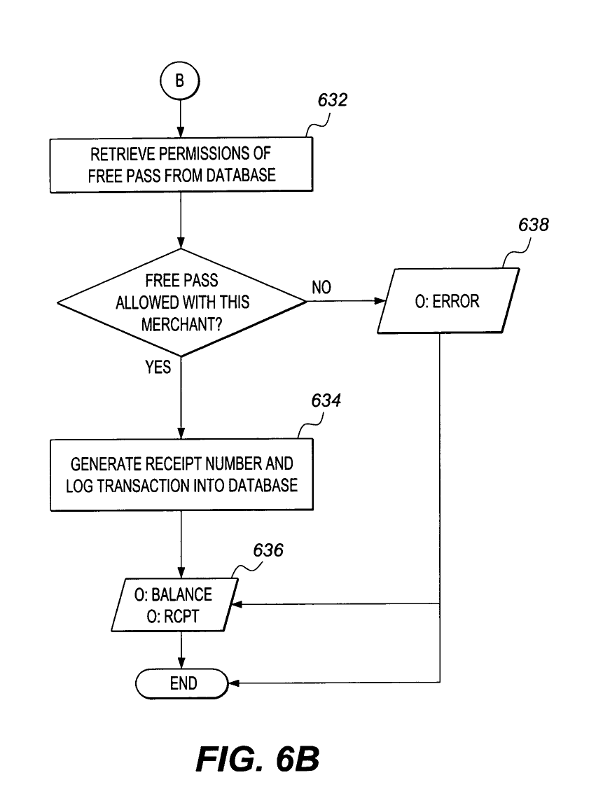

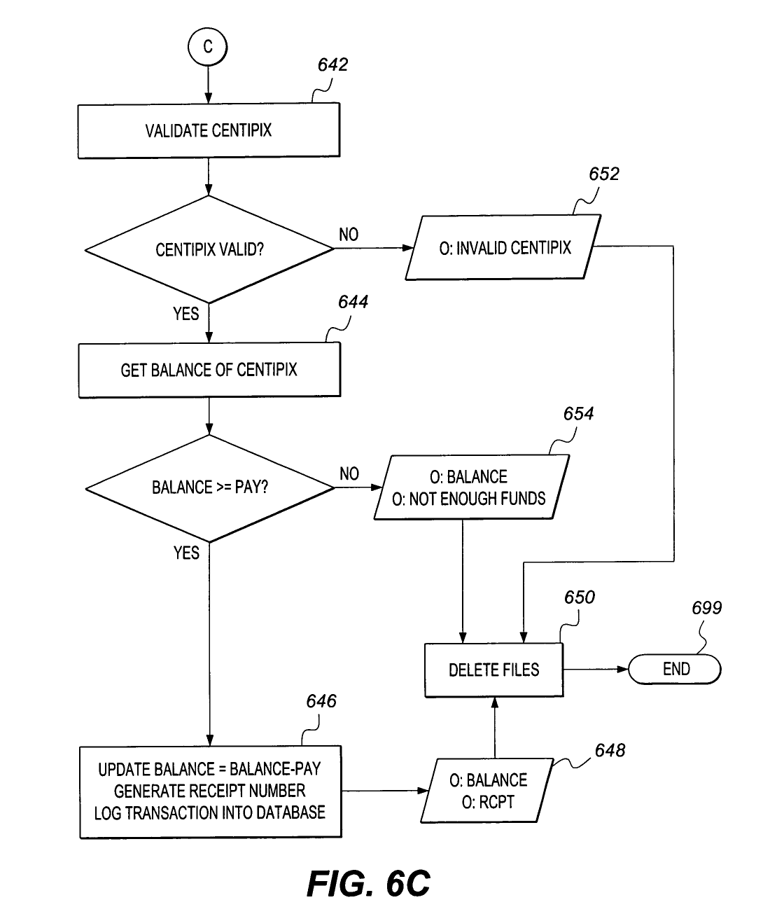

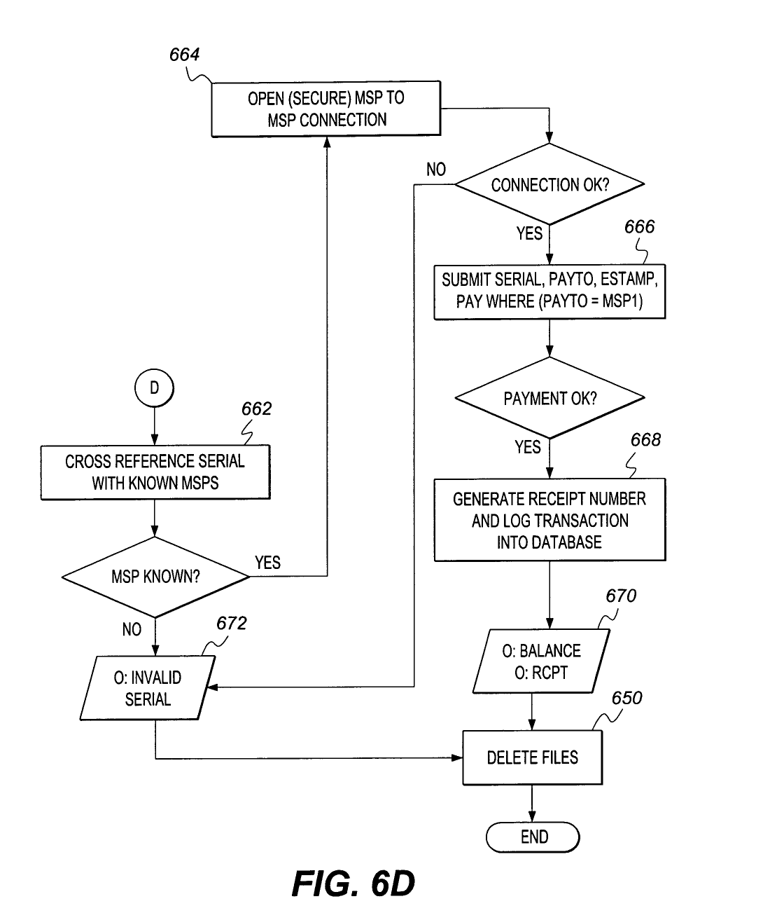

Turning now to FIGS. 6A-6D, a payment server 52 receives and processes requests to make a CENTIPIX payment. The request is parsed and validated. Payment server 52 receives a request in the form:

SERIAL:<the centipix serial number>

PAYTO:<the merchant's identifier>

ESTAMP:<the centipix file>

PAY:<the amount to be paid>

QUIT

The serial number is received and parsed (step 602), and the serial number is checked for validity (step 606). If the serial number is valid, the merchant identifier is received and parsed (step 608). If the serial number is invalid, an error message is generated (step 626) and the request rejected (step 699).

The merchant identifier is checked for validity (step 610). The merchant identifier must identify a merchant that has an account set up with the MSP 50 for payment to the merchant. If the merchant identifier is valid for the MSP, the CENTIPIX file is received and parsed (step 612). If the merchant identifier is invalid, an error message is generated (step 628) and the request rejected (step 699).

The payment amount is received and parsed (step 614). The payment amount is validated to ensure that it is greater than $0.00 (step 616). If the payment amount is invalid, the request is rejected (step 699).

At this point, the payment server 52 determines, from the CENTIPIX serial number, if the CENTIPIX can be paid locally, or must be paid by another MSP 50 (step 604). The handling of CENTIPIX that will be paid by another MSP is discussed below, and detailed in FIG. 6D.

The file signature of the received CENTIPIX file is determined (step 618), and the validation database record for the received serial number is retrieved from the validation database (step 620). A file integrity check is performed, matching the file signature of the received CENTIPIX file to the file signature found in the validation database record (step 622). If the signatures match, the submitted CENTIPIX is good. If the signatures don't match, the submitted CENTIPIX is invalid, and an error message is generated (step 630) and the request rejected (step 699).

The received CENTIPIX may be an ordinary CENTIPIX, or it may be a “free pass.” A free pass CENTIPIX is essentially a CENTIPIX that will be honored by a merchant with no payment being made to the merchant. The payment server 52 determines if the received CENTIPIX is an ordinary CENTIPIX or a free pass (step 624).

Turning to FIG. 6B, if the received CENTIPIX is a free pass, permissions for the free pass are retrieved from a database (step 632). If the free pass is allowed for the merchant identifier, a receipt number is generated, and the transaction logged into a database (step 634). The receipt number is returned to the payment client 24, (step 636). If the free pass is not allowed for the indicated merchant identifier, an error message is generated (step 638) and the process terminated (step 699).

Turning now to FIG. 6C, if the received CENTIPIX is an ordinary CENTIPIX it will be disassembled for authentication and payment (step 642). If the CENTIPIX is valid, the CENTIPIX balance is retrieve from the MSP's database (step 644). If the balance remaining for the CENTIPIX is sufficient to make the requested payment, the payment transaction is completed by updating the CENTIPIX balance (by subtracting the payment amount and any transaction fees from the CENTIPIX balance), generating a receipt number, and logging the transaction into the MSP's database (step 646). Funds subtracted from the CENTIPIX balance are credited to the MSP 50 and the merchant 30, with transaction fees allocated to the MSP 50 and the balance allocated to the merchant 30. The merchant's funds are recorded in a merchant database. The payment server 52 reports the remaining balance and the receipt number to the client (step 648), and then working files are deleted (step 650) and the process is terminated. If the CENTIPIX is invalid, or if there are insufficient funds for the transaction, an error message is reported to the client (steps 652, 654) and then working files are deleted (step 650) and the process is terminated.

Turning to FIG. 6D, a CENTIPIX that was sold by another MSP is routed to that MSP for payment. The serial number is used to determine the MSP that will honor the CENTIPIX for payment (step 662). If the paying MSP cannot be determined, the serial number is deemed invalid and an error message is reported to the client the client (step 672), working files are deleted (step 650) and the process is terminated. IF the paying MSP is found, a secure TCP/IP connection is opened to the paying MSP (step 664). If the connection cannot be established, an error message is reported to the client (step 672) and then working files are deleted (step 650) and the process is terminated.

With a connection successfully established with the paying MSP, the local MSP takes the role of the payment client, and sends a payment request to the paying MSP (step 666). The local MSP essentially forwards the received CENTIPIX payment request to the paying MSP, except the local MSP identifies itself as the PAYTO party. When the local MSP receives a successful payment response from the paying MSP, the local MSP records a receipt number, and logs the transaction, in a database (step 668). The local MSP may use the receipt number received from the paying MSP, or may create a new receipt number. The payment server on the local MSP concludes the transaction by reporting the CENTIPIX remaining balance and the receipt number to the payment client 24 (step 670).

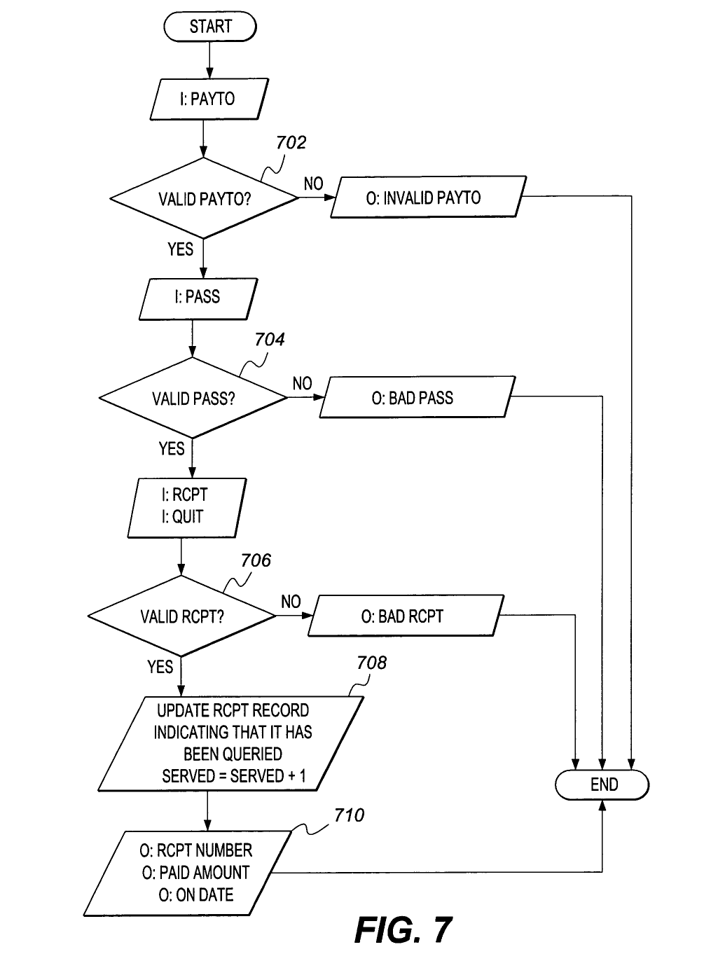

Returning briefly to FIG. 1A, it will be recalled that a receipt is issued to the customer 20 when a CENTIPIX payment is made by the MSP 50. The receipt is forwarded to the merchant 30, and the merchant 30 verifies the receipt with the MSP 50 before providing the product. The receipt is verified by the MSP by a receipt server 56, following generally the process described in FIG. 7. A receipt is verified by sending to the receipt server 56 a request generally of the form:

PAYTO:<the merchant's identifier>

PASS:<a password>

RCPT:<the receipt number>

QUIT

The request is validated by first verifying that the request is made by a valid merchant for the MSP (step 702), then verifying that the correct password has been submitted (step 704), and finally validating the receipt number (step 706). If the request is valid, a receipt database is updated by the MSP 50 to indicate that the receipt number has been queried (step 708). Finally, the receipt server responds with a message indicating the receipt number, the amount paid, and the date paid (step 710).

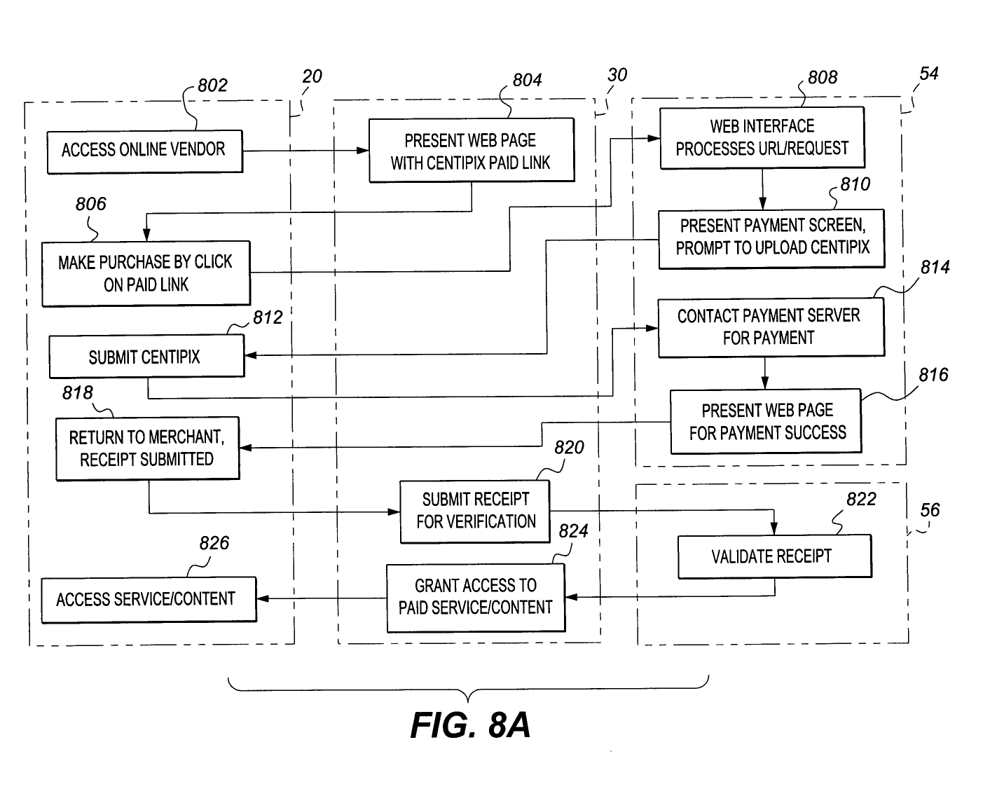

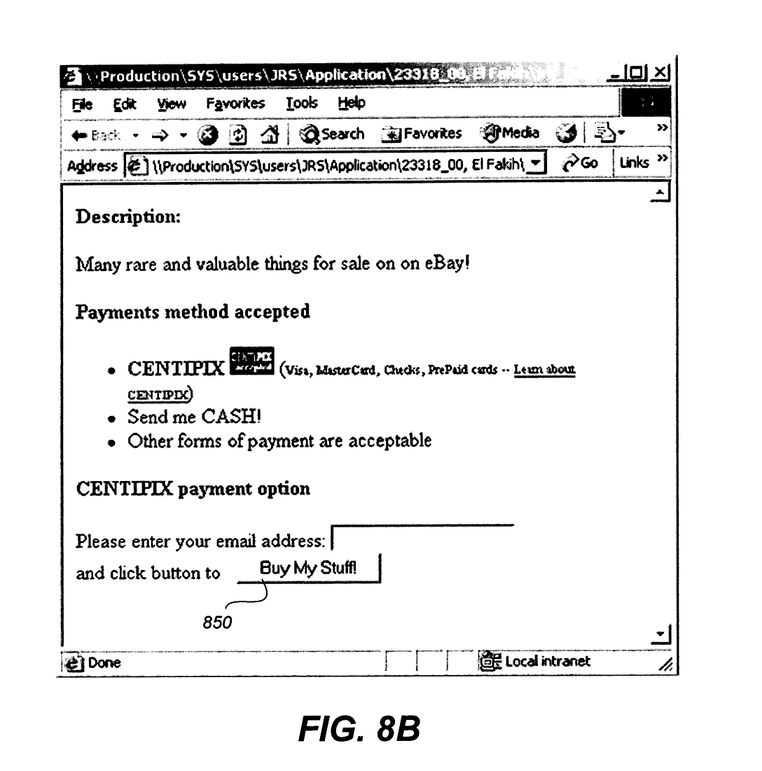

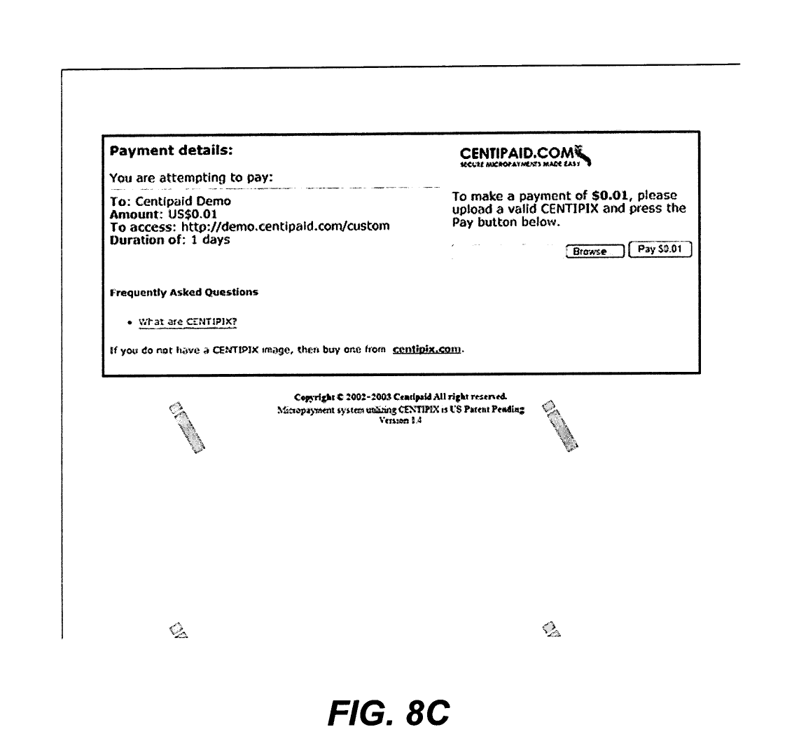

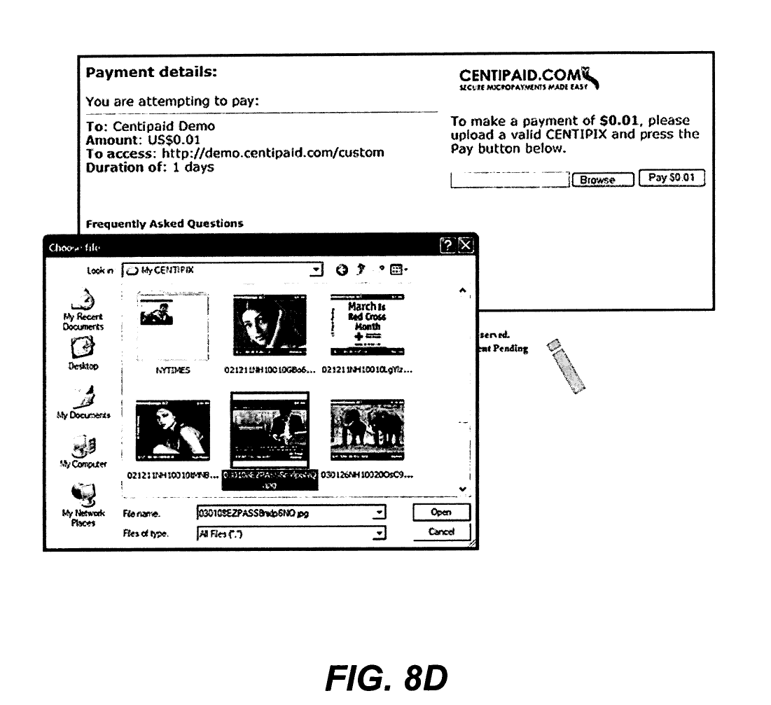

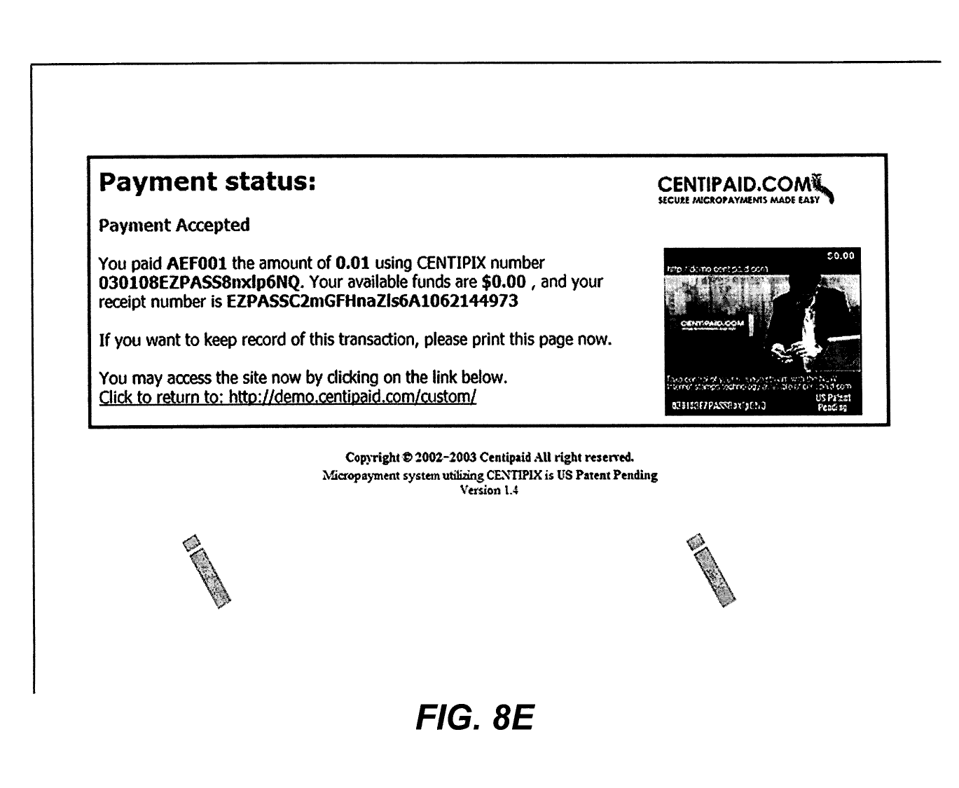

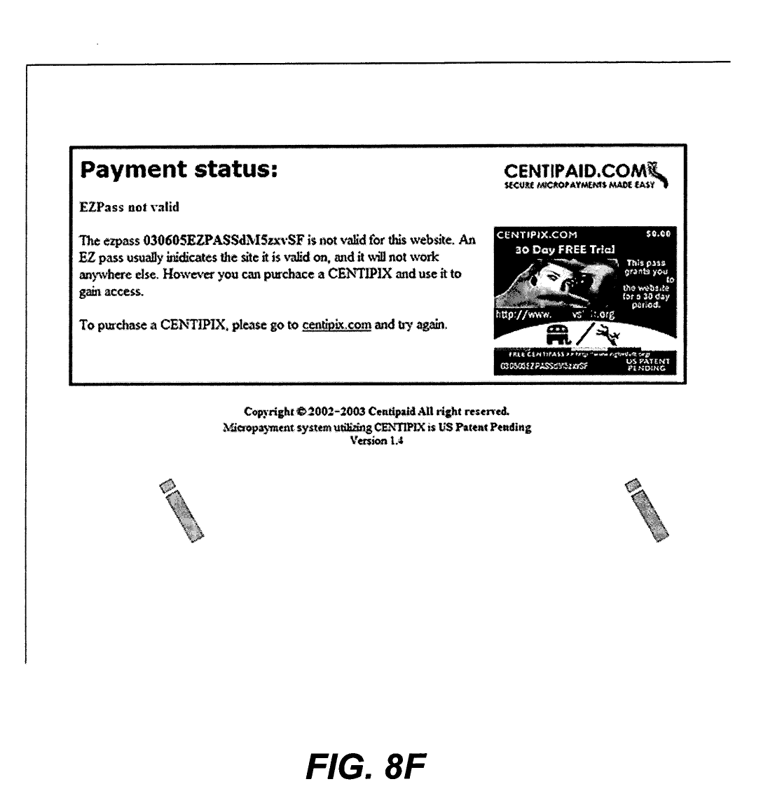

With an understanding of the payment client, web interface, payment server, and receipt server, a typical Internet purchase can be described in greater detail. Referring to FIGS. 8A-8E, an online purchase of a paid service or online content from an Internet merchant is described. The process begins when a customer 20 accesses an online merchant 30, typically by selecting a Web link or URL for redirection to the merchant's website (step 802). The merchant 30 presents a Web page to the customer 20 (step 804). The Web page contains at least one link or URL that is a CENTIPIX paid link. An example of such a Web page is shown in FIG. 8B. The URL underlying a “purchase” button 850 is generally in the form:

http://pay.msp_wi.com/?payto=X&item=1234&amount=3.5

where “pay.msp_wi.com” is the Web domain name of MSP's web interface 54. The URL includes parameters identifying the item purchased (“item”), the amount to pay (“amount”), and the party that is to be paid (“payto”). The customer 20 purchases the content or service by clicking on the “purchase” button 850 (step 806), accessing the URL at the MSP's web interface 54. At the MSP, the web interface 54 processes the URL request (step 808), presenting the customer 20 with a web page requesting the customer 20 to upload a CENTIPIX (step 810). An example of such a Web page is shown in FIGS. 8C and 8D. The web page allows the customer 20 to select and upload a CENTIPIX (step 812).

The web interface 54 receives the CENTIPIX and, along with the payment information previously received, generates a payment request and contacts the payment server 52 (step 814). The web interface 54 generates a payment status web page to report to the customer 20 the status of the payment (step 816). FIG. 8E shows an example of a web page reporting that the payment was accepted, while FIG. 8F shows an example of a web page reporting that the CENTIPIX was not accepted. If payment is accepted, the payment status web page includes a return link to return to the merchant 30. The URL underlying the return link includes transaction information and a payment receipt number. The customer 20 then returns to the merchant 30 by selecting the return link (step 818). The merchant 30 processes the link by submitting the receipt number to the receipt server 30 (step 820). After the receipt server 56 validates the receipt, and returns a successful validation response to the merchant 30 (step 222) the merchant 30 grants access to the content or service to the customer 20 (step 824).

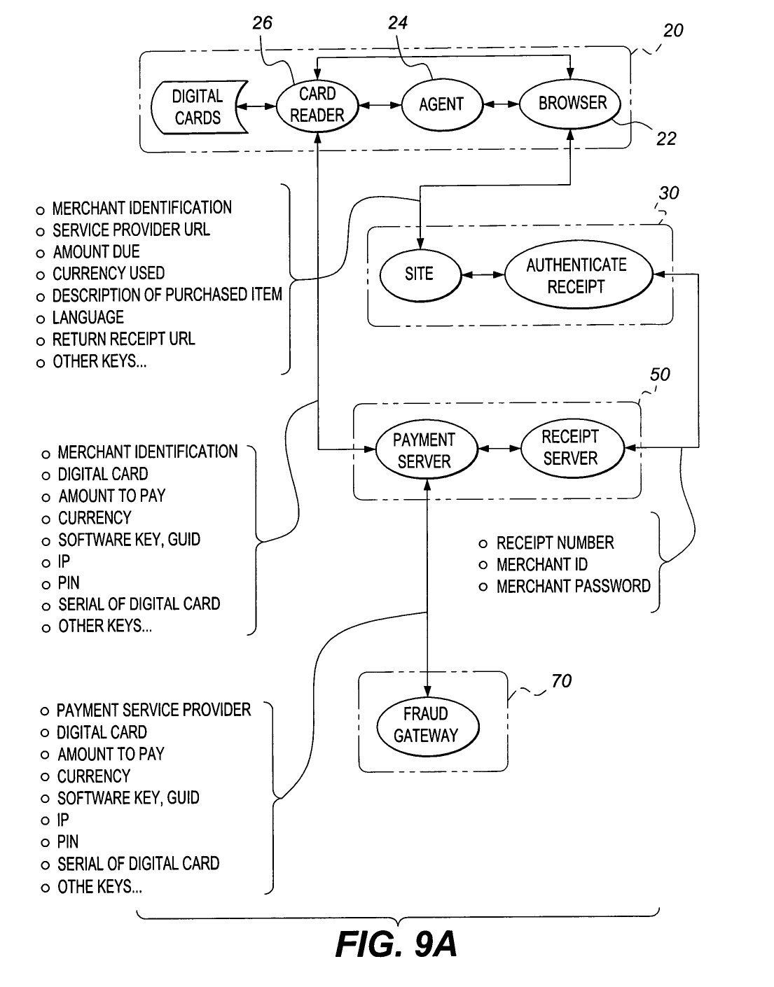

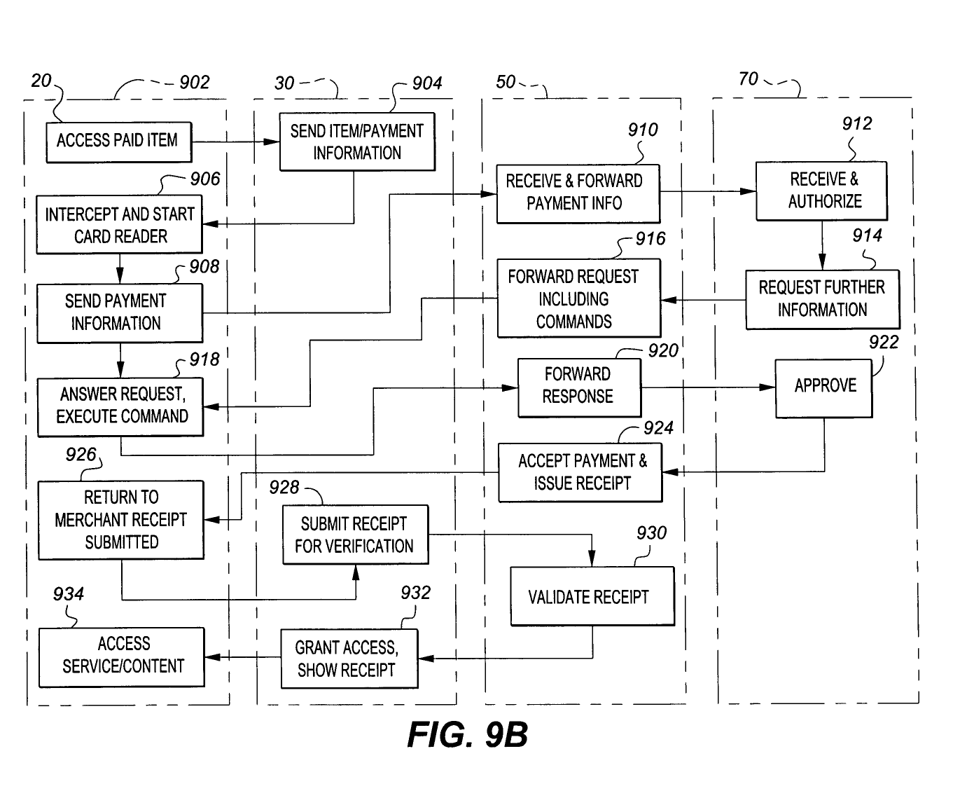

In an alternative embodiment, described in FIGS. 9A and 9B, the CENTIPIX functions as an electronic, or digital, credit card. The digital credit card is constructed as described above, except that a credit card number is used for the CENTIPIX serial number. While the CENTIPIX described above can be used by a customer with no additional software installed on the customer's PC, the digital credit card is used with a “digital card reader” installed to work along with the customer's Web browser. The “digital card reader” is a specialized payment client that communicates with the payment server to provide a digital credit card, and additional authentication information requested by the payment server. The primary difference between the use of a CENTIPIX and the use of a digital credit card is that the use of a CENTIPIX requires no authenticating information to be entered by the CENTIPIX user, while such information may be requested from the digital credit card user. Additionally, the MSP 50 (referred to in this context as a payment service provider or PSP 50) forwards the CENTIPIX or digital credit card to the credit card's issuing bank 70 for payment.

The card reader 26 serves as an application to perform several functions for the digital cards. The digital card reader stores digital cards when not in use. The digital card reader can be used to unlock and copy digital cards to another media. This is done by decrypting the digital card using the, and copying to a portable media for use at another location. The digital card 26 reader further monitors payment requests: The reader intercepts payment requests, and engages the payment process described in this section.

The digital card 26 reader processes payment transactions, allowing the buyer to provide information required for authenticating payment in an interactive or unattended fashion.

The card reader 26 keeps tracks of payments, names of companies paid, services rendered, subscription expiration dates, etc., and allows the export of financial data to other applications.

The card reader 26 interacts with an issuing bank to add or change PIN codes and other authenticating information and permissions for the digital card.

The card reader 26 maintains a globally unique identification (GUID) number that is used in reporting to payment gateways.

A transaction using the digital credit card is described in FIG. 9B. A customer 20 visits merchant 30, selects an item to buy, and proceeds to checkout, choosing the digital card payment option (step 902). The merchant 30 returns a special HTTP header (or equivalent) with embedded payment information which includes at least merchant identification, service provider URL, amount due, currency used, description of the purchased item, language, and a return receipt URL (step 904).

As the browser 22 receives the http request, a monitor agent 24 is alerted to the payment information in the HTTP header, and invokes the card reader 26 and passes the payment information to the card reader program (step 906).

The card reader 26 starts, and displays payment information received from the merchant. The customer 20 is prompted to select a digital card on file for payment.

The customer 20 selects the digital card to use for the transaction, and confirms payment request.

The card reader 26 prompts the customer 20 to enter a PIN code, or other authenticating data, associated with the digital card before processing the payment. Once the authenticating data is verified the process continues.

The card reader prepares the information to be transmitted to the service provider. The least amount of information required includes merchant identification, the digital card, the amount and currency to pay, the GUID, the PIN code, and the serial number of the digital card.

The card reader 26 establishes a secure connection with a payment service provider (PSP) 50 URL and sends information to the PSP (step 908).

The PSP 50 receives information, checks for merchant information, performs currency conversions, and conducts a preliminary fraud check.

The PSP 50 forwards the payment information to its issuing bank (IB) 70, clearinghouse, or other entity with access to digital card authorization keys (step 910).

IB 70 will attempt to authorize digital card using a process similar to the validation process described previously in FIG. 3 or the payment server process described previously in FIGS. 6A-6D. The IB 70 may employ additional steps necessary to authenticate the digital card purchase (step 912).

If the transaction is suspicious, or a value to risk index is too high, the IB 70 can request further authenticating information from the buyer such as the buyer's birthday, mother's maiden name, social security number, address etc. This is done by sending a request back to the customer 20, forwarding the request through the PSP 50 (step 914) to the card reader 26 and to the customer 20 (step 916). The customer 20 must answer the questions correctly to lower the risk index and authorize the transaction. The data is encrypted and transmitted back to IB 70 through the same channel (steps 918, 920).

Once confirmed, IB 70 issues an approval code, which is returned to the PSP; and optionally the IB 70 can force a change of PIN to be sent back with the receipt request to the card reader 26 (step 922).

If the transaction was deemed fraudulent, the IB 70 can select to issue a “delete digital card” command to the card reader 26, along with instructions that the digital card is no longer valid and how to obtain a new one.

The PSP 50 records the transaction, credits the merchant 30, and issues a unique receipt number (RCPT). The receipt number is returned along with optional PIN changes. The receipt number (RCPT) is valid only for the transaction between the merchant 30 and the customer 20 (step 924).

The card reader 26 receives payment information, including the receipt number and an optional PIN change. If a PIN change is requested, the digital card is encrypted using the new PIN and the customer 20 is informed to check his email for the new PIN for future transactions. The receipt number is forwarded to the PSP 50 (step 926).

The merchant 30 receives the receipt number from customer 20 (step 928). The merchant 30 then contacts PSP 50 over secure channel and checks receipt as described previously in FIG. 7 (step 930). Once receipt is authenticated, the merchant 30 informs the buyer 20 that payment has been accepted, and order has been placed (step 932).

CENTIPIX authentication can also be used to verify that identification documents such as ID cards and passports have not been tampered with. This application could be applied to passports, driver licenses, and other forms of image based identification documents. For this application, a CENTIPIX is assembled using a carrier image 150 that is a visual representation of the ID that is being protected. In the case of a passport, the image is preferably of the passport page that includes the passport number, picture, issuing office, and personal information. The CENTIPIX is then assembled as described above. For this application, the CENTIPIX is preferably stored in digital form on the passport or ID card itself on a machine-readable read-only storage media. All the keys are saved as before, and maintained in a central database.

To verify a CENTIPIX-authenticated passport or ID card, the CENTIPIX is read from the read-only storage media. The CENTIPIX image 152 is displayed to the security personnel to visually examine the identification document and the image presented while verification takes place. As the image is being displayed to the security personnel, the digital CENTIPIX is sent to a verification center, which functions similarly to the MSP 50 to validate the CENTIPIX. For added security, the verification center can perform a pixel level comparison of the received CENTIPIX image. If the CENTIPIX is valid, a positive response is sent. Otherwise, the passport reader is alerted to take appropriate actions.

It is to be understood that the present invention is not limited to the embodiments described above, but encompasses any and all embodiments within the scope of the following claims.

I claim:

1. A method of making payments in electronic commerce using electronic stamps, comprising the steps of:
delivering an electronic stamp from a payment service provider to a customer, the electronic stamp comprising an electronic carrier media containing validation data, the electronic stamp having associated therewith validation data stored in a validation database accessible by the payment server and accounting data stored in an accounting database accessible by the payment service provider; and
receiving a copy of said electronic stamp transferred from said customer to said payment service provider, said payment service provider allocating funds associated with said electronic stamp to said merchant.

2. The method of making payments in electronic commerce using electronic stamps according to claim 1, further comprising the steps of:
transferring said electronic stamp from said payment service provider to another payment service provider for payment; and
receiving from said another payment service provider a payment credit of funds associated with said electronic stamp.

3. The method of making payments in electronic commerce using electronic stamps according to claim 1, further comprising the step of assembling said electronic stamp.

4. The method of making payments in electronic commerce using electronic stamps according to claim 2, wherein said assembling step further comprises the steps of:
providing an electronic carrier media, the electronic carrier media being a data file;
selecting a serial number to uniquely identify the electronic stamp;
storing said serial number in a data file;
recording said serial number in a validation database; and
embedding said data file within said electronic carrier media.

5. The method of making payments in electronic commerce using electronic stamps according to claim 4, wherein said electronic carrier media comprises an image file.

6. The method of making payments in electronic commerce using electronic stamps according to claim 5, further comprising altering said image file to include a visual representation of said serial number.

7. The method of making payments in electronic commerce using electronic stamps according to claim 5, further comprising altering said image file to include a visual representation of a face value.

8. The method of making payments in electronic commerce using electronic stamps according to claim 5, wherein said embedding step further comprises using a steganographic technique to embed said data file within said image file.

9. The method of making payments in electronic commerce using electronic stamps according to claim 5, wherein said embedding step further comprises encrypting said data file.

10. The method of making payments in electronic commerce using electronic stamps according to claim 1, wherein said receiving step further comprises:
generating a receipt identifying the payment transaction and recording the receipt in a receipt database;
submitting said receipt to said merchant; and
receiving presentment of said receipt from said merchant and providing said merchant with a receipt validation status.

11. The method of making payments in electronic commerce using electronic stamps according to claim 4, wherein said serial number uniquely identifies a credit card account.

12. The method of making payments in electronic commerce using electronic stamps according to claim 11, wherein said receiving step further comprises the steps of:
using an electronic card reader to select an electronic stamp for payment; and
communicating said electronic stamp from said payment service provider to a credit card issuing bank for payment in order to cause a payment to said payment service provider.

13. The method of making payments in electronic commerce using electronic stamps according to claim 12, further comprising the steps of:
communicating a request for additional information from said credit card issuing bank; and
communicating a reply to said request for additional information to said credit card issuing bank.
